(19) United States
(12) Patent Application Publication
(10) Pub. No.: US 2007/0257900 A1
(43) Pub. Date: Nov. 8, 2007

(54) Visual Display Device and Method for Switching a Visual Display Device to an Energy-Saving State

(75) Inventor: Rudiger Schulz, Bobingen (DE)

Correspondence Address: EDELL, SHAPIRO & FINNAN, LLC, 1901 RESEARCH BOULEVARD, SUITE 400, ROCKVILLE, MD, 20850, US

(73) Assignee: Fujitsu Siemens Computers GmbH, Munich (DE)

(21) Appl. No.: 11/744,988

(22) Filed: May 7, 2007

(30) Foreign Application Priority Data
May 8, 2006 (DE) 102006021388.2

(51) Int. Cl. G09G 5/00

(52) U.S. Cl. 345/211

(57) ABSTRACT

A visual display device includes a display unit and a signal input for connection to a computer. The visual display device includes an energy-saving state controller with a monitoring unit for determining whether the image signals applied to the signal input satisfy predetermined criteria during a predetermined time. The energy-saving state controller is configured to switch the visual display device between a normal operating state and an energy-saving state with reduced energy consumption in the event the predetermined criteria is satisfied.

### CROSS REFERENCE TO RELATED APPLICATIONS

This application claims priority under 35 U.S.C. §119 to Application No. DE 102006021388.2 filed on May 8, 2006, entitled “Visual Display Unit and Method for Controlling a Visual Display Unit into an Energy-Saving State,” the entire contents of which are hereby incorporated by reference.

### FIELD OF THE INVENTION

A visual display device comprising a display unit and a signal input for connection to a computer and a method for switching a visual display device between a normal operating state and an energy-saving state are described herein.

### BACKGROUND

Visual display devices in the form of CRT monitors or flat screens are widely known. Visual display devices for computers are typically in constant operation. In contrast, the pure usage time (i.e., the time during which the displayed screen contents change as a result of a user operating the computer), is often only a fraction of the operating time. As a result, visual display devices may be permanently damaged (e.g., as a result of burning of an electron beam in the case of CRT monitors). TFT monitors also have a memory effect: when image contents do not change, the liquid crystal molecules are aligned in a particular manner and may become sluggish if they are not moved. As in the case of burning in CRT monitors, the effect is irreversible but may be effectively prevented by using a screen saver, for example.

In order to protect visual display devices from permanent damage, it is a known practice for a computer to switch a connected visual display device into an energy-saving state. This may be effected in accordance with the VESA-DPM standard. The period of time before a connected visual display device changes to the energy-saving state is set by the user in the operating system of a computer. After this predetermined time has elapsed, the computer switches the connected visual display device into an energy-saving state.

### SUMMARY

Described herein is a visual display device with an improved energy-saving and protective function.

The visual display device comprises a display unit, a signal input for connection to a computer, and an energy-saving state controller with a monitoring unit for determining whether the image signals applied to the signal input satisfy predetermined criteria during a predetermined time. The energy-saving state controller is configured to control, (i.e., switch) the visual display device into an energy-saving state with a reduced energy consumption if the result of the determination is positive.

Furthermore, a method for controlling a visual display device into an energy-saving state is also described herein. According to the method, a visual display device switches to an energy-saving state if the image signals applied to the signal input satisfy predetermined criteria over a predetermined time.

In one embodiment, the energy-saving state controller includes a timer. The energy-saving state controller compares the current value of the timer with a predefined value. The predefined value corresponds to the predetermined time. After the predetermined time has expired, the energy-saving state controller switches the visual display device into the energy-saving state if the image signals applied to the signal input satisfy the predetermined criteria. If the image signals applied to the signal input do not satisfy the predetermined criteria, the monitoring unit of the energy-saving state controller resets the timer to a start value.

In another embodiment, the energy-saving state controller switches the visual display device into the energy-saving state if the predetermined criteria have been satisfied by virtue of the image contents determined by the image signals remaining unchanged over the predetermined time.

In another embodiment, the energy-saving state controller switches the visual display device into the energy-saving state if the predetermined criteria have been satisfied by virtue of the image contents determined by the image signals changing according to a fixed pattern over the predetermined time.

During the energy-saving state of a visual display device, the energy-saving state controller remains activated in so far as the image contents of the image signals transmitted from a computer to the visual display device are monitored. If it is determined in this case that the image signals do not satisfy the predetermined criteria, the visual display device is switched back into a normal operating state.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The visual display unit and method are explained in more detail below with reference to the accompanying drawings, where:

FIG. 1 shows a first exemplary embodiment of a visual display unit comprising a visual display device and a computer;

FIG. 2 shows another exemplary embodiment of the visual display unit;

FIG. 3 shows a state diagram of an exemplary method for switching a visual display device between a normal operating state and an energy-saving state;

FIG. 4 shows a detailed flowchart of step S1 in FIG. 3 in accordance with an exemplary embodiment of checking the image contents of applied image signals;

FIG. 5 shows a detailed flowchart of step S3 in FIG. 3 in accordance with an exemplary embodiment of checking the image signals; and

FIG. 6 shows a detailed flowchart of step S4 in FIG. 3 in accordance with an exemplary embodiment for checking of the image signals.

### DETAILED DESCRIPTION

In the following paragraphs, exemplary embodiments of the device and method are described in connection with the figures.

The terms “image signal” or “image contents” are used alongside one another below, in which case it is usually the image contents which are important for determining whether predetermined criteria have been satisfied.

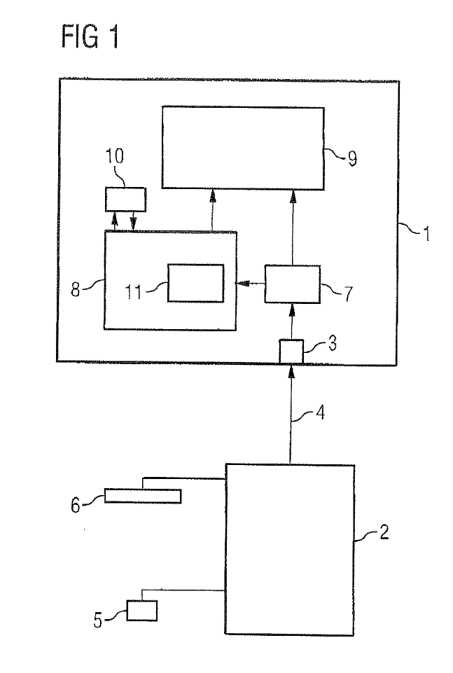

FIG. 1 shows, as a first exemplary embodiment, an arrangement comprising a visual display device 1 and a computer 2. The visual display device 1 includes a signal input 3 connected to the signal output of the computer 2 via a connecting line 4. A computer mouse 5 and a keyboard 6 are connected to the computer 2.

The visual display device 1 comprises a control unit 7, an energy-saving state controller 8 and a display unit 9 which is set up to display an image signal received via the signal input 3. The energy-saving state controller 8 is connected to a timer 10 and includes a monitoring unit 11.

An image signal which is received by the visual display device 1 via the signal input 3 is forwarded by the control unit 7 to the display unit 9. The control unit 7 forwards the information which is contained in the image signals and relates to the image contents to the energy-saving state controller 8 and to the display unit 9 in a parallel manner. The image contents received are checked by the monitoring unit 11. The display unit 9 is also driven by the energy-saving state controller 8 in order to switch off the background lighting in the energy-saving state, for example.

In a normal operating state, the image signal is received via the signal input 3 and is forwarded by the control unit 7 to the display unit 9. The image signal generated by the computer 2 is then displayed on the display unit 9 of the visual display device 1.

Image contents are received by the monitoring unit 11 via the control unit 7 and are stored in an image memory. An image comparator of the monitoring unit 11 is used to continuously compare the image contents of a subsequent image with the image contents stored in the image memory. To this end, the image contents of the subsequent image are likewise stored in the image memory in this exemplary embodiment.

If the image contents of the subsequent image do not satisfy predetermined criteria, the timer 10 is reset to a start value by the monitoring unit 11. The predetermined criteria are preferably image contents which do not change or image contents which change according to a particular pattern.

The criterion of image contents which change according to a particular pattern has been satisfied, for example, if the image contents displayed by the display unit 9 contain a flashing cursor whose position does not change. An activated screen saver also satisfies the criterion of image contents which change according to a particular pattern, for example.

If the image contents of the second image signal satisfy the predetermined criteria, the time recorded by the timer 10 since the last change in received image contents is compared with a predefined value by the energy-saving state controller 8. If the current value of the time recorded by the timer 10 is greater than the predefined value, the energy-saving state controller 8 controls the visual display device 1 into an energy-saving state with reduced energy consumption. If the second image contents do not satisfy the predetermined criteria, the timer 10 is reset and the second image contents are used as the first image contents for subsequent comparisons.

In the energy-saving state, components of the visual display device 1 are turned off. In the case of a CRT visual display device, the cathode heater and the high voltage could be turned off, for example. The energy-saving state of an LCD monitor is distinguished, for example, by the fact that the background lighting and the 12 V driver voltage for the LCD panel are turned off. As a result, the display unit 9 is driven by the energy-saving state controller 8 in such a manner that an image signal is not displayed.

If the visual display device 1 is in the energy-saving state and if the computer mouse 5 is moved, for example, by the user of a computer 2, the mouse pointer also moves. This results in a change in the image signals transmitted from the computer 2 to the visual display device 1 and thus in a change in the image contents. Such a change in the image contents results in the visual display device 1 being switched back into the normal operating state from the energy-saving state by the energy-saving state controller 8.

In contrast, in a state in which there is no activity, that is to say a user does not use the computer 2, the image signals transmitted from the computer 2 to the visual display device are the same and the visual display device 1 remains in the energy-saving state.

The described visual display device 1 makes it possible for the user to use a setting menu of the visual display device 1 to set the value for the predetermined time after whose expiry the visual display device switches to the energy-saving state. Furthermore, control of the visual display device 1 into the energy-saving state can be deactivated. The inventive visual display device 1 thus also enables use solely according to the known prior art in which the computer 2 signals that an energy-saving state has been assumed. On the other hand, an inventive visual display device 1 makes it possible to switch into an energy-saving state even if the computer 2 is not configured for this.

When the described visual display device 1 is used, it is possible to deactivate or completely dispense with signaling between the computer 2 and the visual display device 1 in order to assume an energy-saving state according to the known prior art.

The computer 2 is, for example, a personal computer with an installed graphics card. For example, a VGA graphics card can be used to provide an image signal at an image output of the computer 2. However, the manner in which the image signals are generated is not essential to the invention since an inventive visual display device 1 functions irrespective of the configuration of the computer 2 to which it is connected. Image signals which are to be displayed are transmitted from the computer 2 to the visual display device 1 via analog or digital signals.

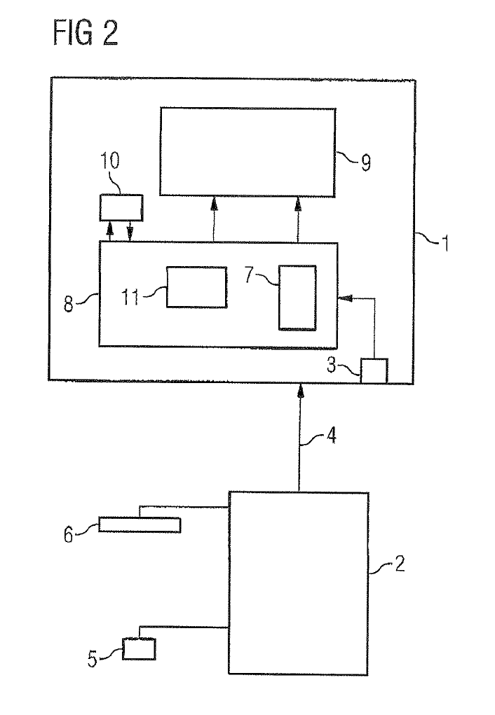

FIG. 2 shows another exemplary embodiment. The control unit 7 is integrated in the energy-saving state controller 8. The image signals received by the visual display device 1 are forwarded to the display unit 9 by the energy-saving state controller 8. Driving of the display unit 9 for displaying an image signal is preferably separate from control into an energy-saving state in order to avoid distorting or delaying the image signal. The energy-saving state controller 8 controls the visual display device 1 into the energy-saving state when the image signals applied to the signal input 3 satisfy the predetermined criteria during the predetermined time.

Further exemplary embodiments in which, for example, the control unit 7 comprises a monitoring unit 11 and only the result of a check of the image contents of applied image signals is forwarded to the energy-saving state controller 8 are not discussed in any more detail here but are encompassed by the invention.

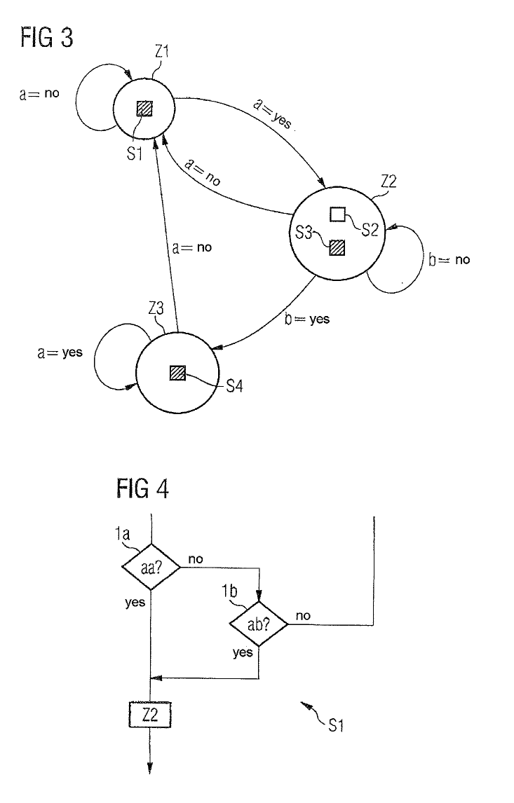

FIG. 3 shows a state diagram of a method for controlling the visual display device 1 into the energy-saving state according to one embodiment. As explained in detail below, the image signals applied to the signal input 3 of the visual display device 1 are monitored. In a simple case, image signals satisfy the predetermined criteria if, for example, the image contents of an applied image signal do not change in comparison with stored image contents of an image signal.

After it has been turned on, the visual display device 1 is in a normal operating state Z1. In a step S1, the monitoring unit 11 checks whether a transition condition a (i.e., “Does the image signal satisfy predetermined criteria?”) has been satisfied. If the result of the determination is positive, the visual display device 1 changes to a waiting state Z2. If the result of the determination is negative, in other words, the applied image signal does not satisfy the predetermined criteria, the monitoring unit 11 resets the timer 10 to a start value and the visual display device 1 remains in the normal operating state Z1.

If the visual display device has changed to the waiting state Z2, the monitoring unit 11 checks, in a step S2, whether a transition condition b, that is to say “Is the current value of the timer 10 greater than a predefined value?”, has been satisfied. If the result of the determination is positive, the visual display device 1 changes to an energy-saving state Z3. If the result of the determination is negative, i.e., the current value of the timer is less than a predefined value, the monitoring unit 11 checks, in a step S3 corresponding to step S1, whether the transition condition a continues to be satisfied for a next applied image signal. If the result of the determination is positive, the visual display device 1 remains in the waiting state Z2. If the result of the determination is negative, the monitoring unit 11 resets the timer 10 to the start value and the visual display device 1 changes to the normal operating state Z1.

If the visual display device has changed to the energy-saving state Z3, the monitoring unit 11 checks, in a step S4 corresponding to step S1, whether the transition condition a has been satisfied for applied image signals. If the result of the determination is positive, the visual display device 1 remains in the energy-saving state Z3. If the result of the determination is negative, the monitoring unit 11 resets the timer 10 to the start value and controls the visual display device 1 back into the normal operating state Z1.

FIG. 4 shows part of a detailed flowchart with an embodiment for checking of the image contents of applied image signals in step S1. In an exemplary case, the image signals satisfy the predetermined criteria if, e.g., the image contents do not change or if the image contents change according to a particular pattern. In another embodiment of the described method, only individual criteria of the criteria mentioned are checked.

In a step 1a, the monitoring unit 11 checks whether a transition condition aa “the image contents have not changed” has been satisfied. If the result of the determination is positive, the visual display device 1 changes to the waiting state Z2. If the result of the determination is negative, the monitoring unit 11 checks, in a step 1b, whether a transition condition ab “the image contents change according to a particular pattern” has been satisfied. If the result of the determination is positive, the visual display device 1 changes to the waiting state Z2. If the result of the determination is negative, the monitoring unit 11 resets the timer 10 to the start value and the visual display device 1 changes to the normal operating state Z1.

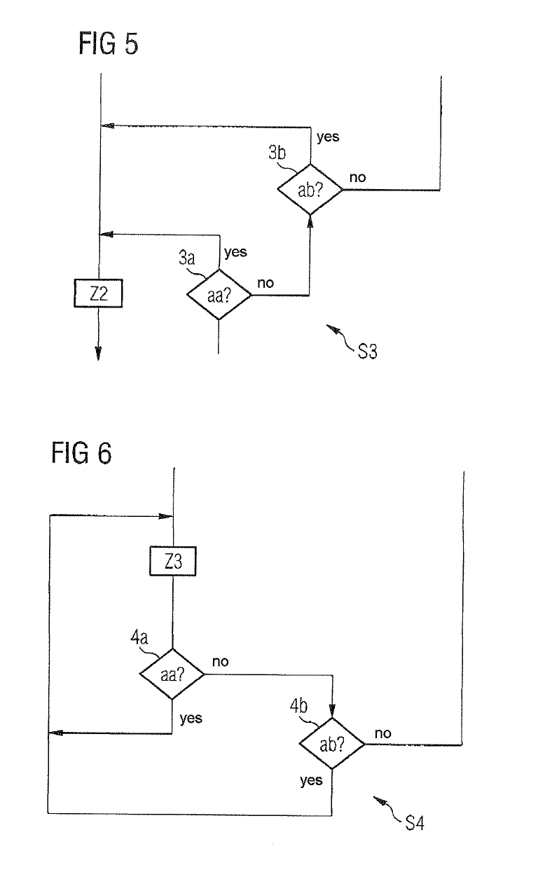

FIG. 5 shows the relevant part of a detailed flowchart for checking the image signals for step S3 as well.

In a step 3a, the monitoring unit 11 checks whether the transition condition aa has been satisfied. If the result of the determination is positive, the visual display device 1 remains in the waiting state Z2. If the result of the determination is negative, the monitoring unit 11 checks, in a step 3b, whether the transition condition ab has been satisfied. If the result of the determination is positive, the visual display device 1 remains in the waiting state Z2. If the result of the determination is negative, the monitoring unit 11 resets the timer 10 to the start value and the visual display device 1 changes to the normal operating state Z1.

FIG. 6 shows the relevant part of a flowchart for detailed checking of the image signals for step S4 as well.

In a step 4a, the monitoring unit 11 checks whether the transition condition aa has been satisfied. If the result of the determination is positive, the visual display device 1 remains in the energy-saving state Z3. If the result of the determination is negative, the monitoring unit 11 checks, in a step 4b, whether the transition condition ab has been satisfied. If the result of the determination is positive, the visual display device 1 remains in the energy-saving state Z3. If the result of the determination is negative, the monitoring unit 11 resets the timer 10 to the start value and the visual display device 1 changes to the normal operating state Z1.

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. A visual display device, comprising:
a display unit operable to be switched between a normal operating state and an energy-saving state with a reduced energy consumption;
a signal input for connection to a computer; and
an energy-saving state controller including a monitoring unit for determining whether the image signals applied to the signal input satisfy predetermined criteria during a predetermined time;
the energy-saving state controller being operable to switch the visual display device to the energy-saving state in response to the monitoring unit determining the criteria is satisfied in the predetermined time.

2. The visual display device according to claim 1, wherein:
the energy-saving state controller further comprises a timer, the energy-saving state controller being operable to compare a current value of the timer with a predefined value corresponding to the predetermined time; and
the monitoring unit is operable to reset the timer to a start value in the event, before the predefined value is reached, the monitoring unit determining that the image signals applied to the signal input do not satisfy the predetermined criteria.

3. The visual display device according to claim 2, wherein the predetermined criteria have been satisfied in the event that image contents determined by the image signals do not change during the predetermined time.

4. The visual display device according to claim 2, wherein the predetermined criteria have been satisfied in the event that image contents determined by the image signals change according to a fixed pattern during the predetermined time.

5. The visual display device according to claim 2, wherein the monitoring unit comprises an image memory for storing image contents.

6. The visual display device according to claim 5, wherein the monitoring unit further comprises an image comparator for comparing first image contents stored in the image memory with second image contents.

7. The visual display device according to claim 6, wherein the second image contents are stored in the image memory.

8. The visual display device according to claim 2, wherein:
in the event the visual display device is in the energy-saving state and the predetermined criteria have not been satisfied, the energy-saving state controller remains activated and detects image contents determined by the image signals transmitted from the computer to the visual display device; and
in the event the visual display device is in the energy-saving state and the predetermined criteria have been satisfied, the energy-saving state controller switches the visual display device to the normal operating state.

9. The visual display device according to claim 2, wherein the predefined value for the predetermined time can be set in the system settings of the computer or via a setting menu of the visual display device.

10. The visual display device according to claim 2, wherein the energy-saving state controller is operable to deactivate the energy-saving state.

11. The visual display device according to claim 1, wherein the predetermined criteria have been satisfied in the event that image contents determined by the image signals do not change during the predetermined time.

12. The visual display device according to claim 1, wherein the predetermined criteria have been satisfied in the event that image contents determined by the image signals change according to a fixed pattern during the predetermined time.

13. The visual display device according to claim 1, wherein the visual display device is configured to be switched into the energy-saving state via signaling from a connected computer.

14. The visual display device according to claim 13, wherein the visual display device is configured to deactivate the energy-saving state via signaling from the connected computer.

15. A method for controlling a visual display device operable to be switched between a normal operating state and an energy-saving state, the method comprising:
determining, in the event the visual display device is in the normal operating state, whether received image contents satisfy predetermined criteria and, in the event the predetermined criteria is satisfied, switching the visual display device to a waiting state;
determining, in the event the visual display device is in the waiting state, whether received image contents satisfy the predetermined criteria and, in the event the predetermined criteria is not satisfied, switching the visual display device to the normal operating state; and
determining, in the event the visual display device is in the waiting state, whether received image contents satisfy the predetermined criteria and, in the event the predetermined criteria is satisfied, determining whether predetermined time criteria have been satisfied and, in the event the predetermined time criteria have been satisfied, switching the visual display device to the energy-saving state.

16. The method according to claim 15, the method further comprising:
comparing received image contents with image contents previously received in order to determine whether the image contents have not change; and
comparing received image contents with image contents previously received in order to determine whether the image contents have changed according to a fixed pattern;
wherein the predetermined criteria is satisfied in the event the image contents have not changed or in the event the image contents have changed according to the fixed pattern.

17. The method according to claim 15, further comprising:
operating a timer; and
determine whether a prescribed period of time has elapsed, wherein the predetermined time criteria are satisfied in the event the prescribed period of time has elapsed.

18. The method according to claim 17, further comprising:
resetting the timer is reset to a start value in the event the predetermined criteria are not satisfied.

19. The method according to claim 15, further comprising:
determining, in the event the visual display device is in the energy-saving state, whether received image contents satisfy the predetermined criteria and, in the event the predetermined criteria is not satisfied, switching the visual display device to the normal operating state.
